(19) United States
(12) Patent Application Publication
(10) Pub. No.: US 2012/0170280 A1
(43) Pub. Date: Jul. 5, 2012

(54) ILLUMINATION APPARATUS USING A SOLID STATE SOURCE AND A THICK COMPOSITE MOLDED LENS

(75) Inventor: Eric CHOQUET, Blainville (CA)

(73) Assignee: DBM REFLEX ENTERPRISES INC., Laval (CA)

(21) Appl. No.: 13/172,093

(22) Filed: Jun. 29, 2011

Related U.S. Application Data
(63) Continuation-in-part of application No. PCT/CA2011/000129, filed on Feb. 1, 2011.
(60) Provisional application No. 61/300,201, filed on Feb. 1, 2010.

(51) Int. Cl. F21V 5/04

(52) U.S. Cl. 362/335

(57) ABSTRACT

A composite high sag thick lens for automotive lighting is used in conjunction with a solid state illumination source, such as a white LED. The composite high sag thick lens is made of a first lens section having an optical active curve surface and a series of elongated baffles, the baffles having a top portion, the top portions defining a line that follows the curvature of the active surface to create an upper lens portion of uniform thickness. A second lens section is fused to the first lens section to create the composite lens. The second lens has an optical active surface and a series of elongated baffles the baffles having a thickness comparable to the thickness of the corresponding optical active surface. The first and the second plurality of baffles are intertwined along the entire length of their lateral surfaces.

### CROSS-REFERENCE RELATED APPLICATIONS

This application is a continuation-in-part of PCT application PCT/CA2011/000129 with an international filing date of Feb. 1, 2011, which is still pending and claims the benefit of 35 U.S.C. 119(e) of U.S. provisional application 61/300,201 filed Feb. 1, 2010, now abandoned. The disclosures of these earlier filed PCT and U.S. provisional applications are herein incorporated by reference.

### FIELD OF THE INVENTION

The present invention relates to an illumination apparatus including a solid state light source optically coupled to a thick lens. More particularly, the present invention relates to a a high sag thick lens made of a plastic material in a multi step process where the lens is free from distortions caused by the manufacturing process, the lens being operable with an LED light source.

### BACKGROUND OF THE INVENTION

Illumination systems for automotive vehicles use powerful incandescent light sources optically coupled to thick glass lenses. Reference is made in this regard to U.S. Pat. No. 7,261,448 to Ishida. The increased amount of heat generated by the light source is handled properly by thick glass lenses that will not deform in use and sometimes cold mirrors and IR filters are used to remove or reduce the heat intensive infrared light spectrum.

High sag thick glass lenses for automotive vehicles are made in many instances by injection molding and reference is made in this regard to the recent US 2006/0072208 to Bonitz, US 2010/0202154 to Hamkens and US 2010/0091511 to Erward.

Advancements in white light solid state illumination sources such as LEDs have been applied to automotive lighting and reference is made in this regard to US 2002/0034081

In some cases these illumination systems use light guides of almost uniform thickness. Reference is made in this regard to U.S. Pat. No. 7,290,906 to Suzuki and U.S. Pat. No. 7,401,963 to Stefanov. In U.S. '963 the waveguide is injection molded of a plastic material such as PMMA. These light guides can be made rather easily using various injection molding methods because they are quite thin.

High sag and thick lenses such as shown in U.S. Pat. No. 7,261,448 to Ishida are not easy to manufacture using injection molding methods because the injection molding process itself may cause deformations of the optical surfaces.

High sag lenses have a high ratio between the thickness of the lens along the central optical axis and the thickness of the lens at the edges.

High sag lenses for non automotive applications are disclosed in U.S. Pat. No. 6,744,563 to Suzuki, U.S. Pat. No. 7,742,383 to Ito and US 2007/0091443 to Lim, Suzuki '563 talks about the difficulty of molding high sag lenses out of glass (see column 4, lines 29-33). Lim '443 shows a multistep molding process where uniform thickness layers are created one on top of the other to form a high sag lens.

High sag lenses of glass and methods of manufacturing are known and reference is made in this regard to USA 2007/0091443 to Lim and USA 2011/0075264 to Chen.

There is a need to replace the glass lenses operable with high power illumination sources such as shown in U.S. Pat. No. 7,261,448 to Ishida with high sag and thick injection molded plastic lenses operable with LED light sources.

Two-step injection molding method are well known. A two-step injection molding process has been used to make corner cube reflectors for automotive tailgate lights such as disclosed in U.S. Pat. No. 7,682,533 and U.S. Pat. No. 7,722,196. In these patents several corner cubes are molded at once in an injection step and a large support common to the corner cubes is molded in a separate injection step.

There is a need to further improve the design of moldable high sag lenses made of plastic materials such as for example PMMA, acrylic and polycarbonate to be used in automotive applications in order to overcome the inherent limitations of the known injection molding and in-mold cooling methods.

### SUMMARY OF THE INVENTION

Glossary of Terms
In this invention the term composite, embedded or integral lens means a lens made of two or more parts, the two parts of the lens being fused together to become the composite lens.
In this invention the term composite, embedded or integral lens, means a lens made of two or more parts where the parts of the lens are not distinguishable or visible with naked eye but they are visible using polarized light, phase contrast microscopy or other known visualization devices or instruments.
In this invention the term fused means the process of securing or bonding two or more lens parts together using a heat based process.
In this invention the term baffle means an elongated portion of a lens section, the lens section being part of a composite, embedded or integral lens. The baffle is a design feature of the composite lens used to facilitate and improve the multi-step manufacturing process.

According to an embodiment of the invention a composite high sag thick lens for automotive lighting is used in conjunction with a solid state illumination source, such as a white LED. The composite high sag thick lens is made of a first lens section having an optical active curved surface and a series of elongated baffles, the baffles having a top portion, the top portions defining a curved line that follows the curvature of the active surface to create an upper lens portion of uniform thickness T, that is comparable or equal to the thickness of the baffles. A second lens section is fused to the first lens section to create the composite thick and high sag lens. The second lens has an optical active surface and a series of elongated baffles the baffles having a thickness comparable to the thickness of the corresponding optical active surface. The first and the second plurality of baffles are intertwined along the entire length of their lateral surfaces and have a comparable or an equal thickness.

In another embodiment of the invention a composite moldable high sag thick lens made of PMMA, acrylic, polycarbonate and other plastic materials for use in automotive lighting applications is specifically designed as a two piece lens to be manufactured using a multi-step manufacturing process, such as a two-step injection molding process using the same moldable material or two moldable materials.

According to another embodiment of the invention the composite lens is designed as two separate lens parts that have a uniform thickness. The uniform thickness is needed in the manufacturing process. Each lens part includes an active optical surface to be exposed to light from a solid state illumination source. Each lens part also includes several baffles dimensioned to have a similar thickness among them and to have a thickness comparable to the thickness of the active optical surfaces of each lens part defined between the optical surface and the end portion of the baffles. The baffles have an end portion and these end portions follow the curvature of the active optical surface of the high sag lens and define the thickness of the active optical surface. When fused together to form the composite high sag lens, the baffles are intertwined or alternate in a cross section without any air gap between them and without affecting the optical and thus the illumination performance of the composite lens. The baffles are invisible by naked eye, they can be seen in polarized light or through other means to check the quality of the composite lens.

According to another embodiment of the invention the composite high sag lens is designed so that the baffles of each lens part is manufactured using a two step injection process of the same resin in two different injection molding cavities. In the first step a first lens part having a first series of elongated baffles is injection molded in a first cavity using molding material MM-A via a first mold cavity gate MG-1. The first lens part is cooled in the first mold cavity. The core retaining the first lens part is transferred to form a second cavity mold using the first lens part as a mold core portion. In the second molding step the baffles of the first lens part are aligned with respect to a second mold cavity gate MG-2 in a manner that allows a second shot of the same material MM-A to flow and fill the second cavity by advancing in the second cavity along the first series of elongated baffles and form the second lens part with a second series of elongated baffles. The second series of elongated baffles are fused with the first series of elongated baffles during the over-molding injection process of a the hot second shot of material MM-A onto the cold and solidified material MM-A to form the composite high sag and thick lens.

According to the invention in the first shot a first amount of molded resin to form a first layer of the thick lens is generated. This first layer includes at least two elongated baffles aligned with respect to a mold gate. In a second shot the first layer is part of the mold cavity and a second shot of the same material is injected over the first layer and in between the at least two baffles through another mold gate. This gate is aligned with the baffles so that the second shot of molten material follows a mold filling path along the side surfaces of the baffles. In this manner the venting of the mold is done properly since there is no surface opposite to the gate and the baffles create channels that allows the removal of air and gas from the cavity and also insuring that no bubbles are formed in the lens.

According to another embodiment of the invention the composite high sag lens is designed so that the baffles of each lens part is manufactured using a two step injection process of the same resin in two different injection molding cavities. In the first step a first lens part having elongated baffles is embossed using a first embossing device. In a second step a second lens part having elongated baffles is embossed using a second embossing device. In a third step, the first and the second lens parts are fused together by sliding on part along or on top of the other by aligning the baffles and heating the assemble to form the composite high sag lens.

### BRIEF DESCRIPTION OF THE DRAWINGS

The invention can be better understood from the following drawings that are intended to provide stand alone or additional and specific design details that do not limit the scope of the invention. Sizes and shapes of the elements of the lens and the mold are approximate and may not be at scale.

FIGS. 1a-b-c-e-f-g show a composite or an integral high sag thick lens according to an embodiment of this invention made of two lens parts each having a series of complementary or intertwined elongated baffles whose end follow the curvature of the optically active lens surfaces

FIG. 1 d shows the composite in an automotive illumination apparatus such as a head lamp.

FIG. 1 h shows two lenses of low and high sag and cooling channels in a mold.

FIG. 2a-b-c show a composite or an integral high sag thick lens according to an embodiment of this invention made of two lens parts each having a series of complementary or intertwined elongated baffles whose end follow the curvature of the optically active lens surfaces.

FIG. 2d-e show a composite or an integral high sag thick lens according to an embodiment of this invention made of two lens parts each having a series of complementary or intertwined elongated baffles whose end follow the curvature of the optically active lens surfaces as seen under polarized light.

FIG. 3 shows the first molded lens section and the baffles positioned to allow the flow of the melt of the second shot without turbulences.

FIG. 4 shows a mold core insert carrying the first molded lens part having elongated baffles being positioned relative the mold gate of a second mold cavity to inject the second shot of molten material.

FIGS. 5a-b-c-d show a cross section through a novel injection mold used to manufacture a novel integral or composite high sag lens made of a plastic material according to an embodiment of the invention.

FIGS. 5e-f-g show a cross section through another cross section through a novel injection mold used to manufacture a novel integral or composite high sag lens made of a plastic material according to an embodiment of the invention.

FIG. 5h shows a rotary mold used to manufacture a novel integral or composite high sag lens made of a plastic material according to an embodiment of the invention.

FIG. 6 shows a prior art high sag lens.

FIG. 7 shows a prior art high sag lens and the method of making a prior art high sag lens for non-automotive applications.

### DETAILED DESCRIPTION OF THE INVENTION

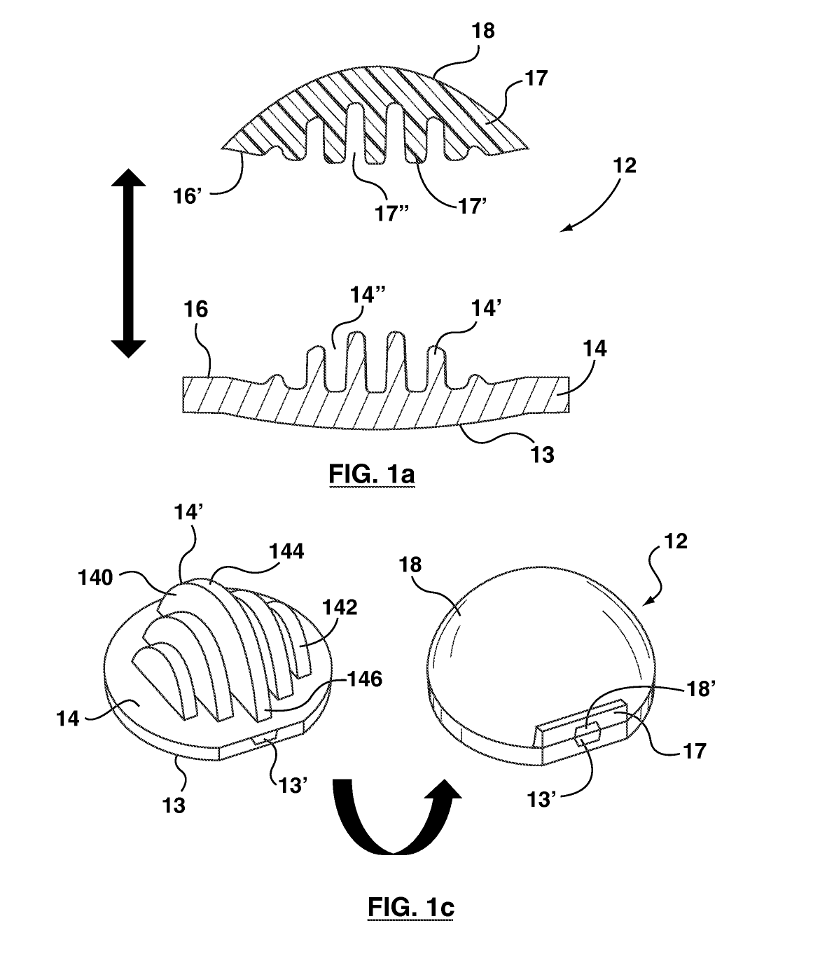

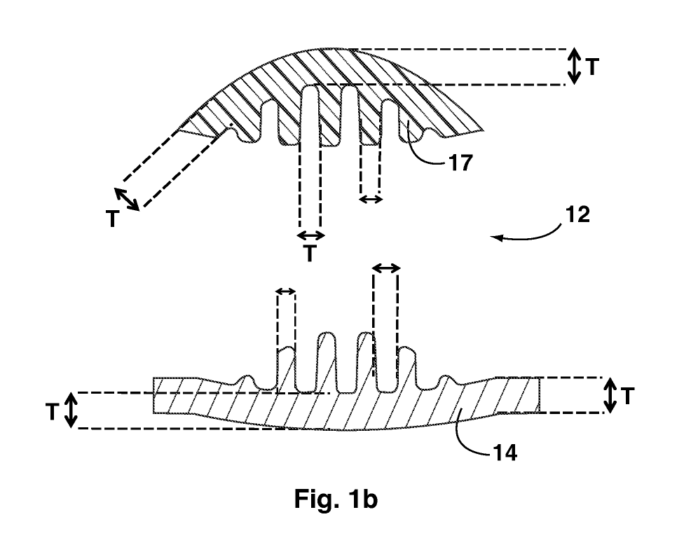

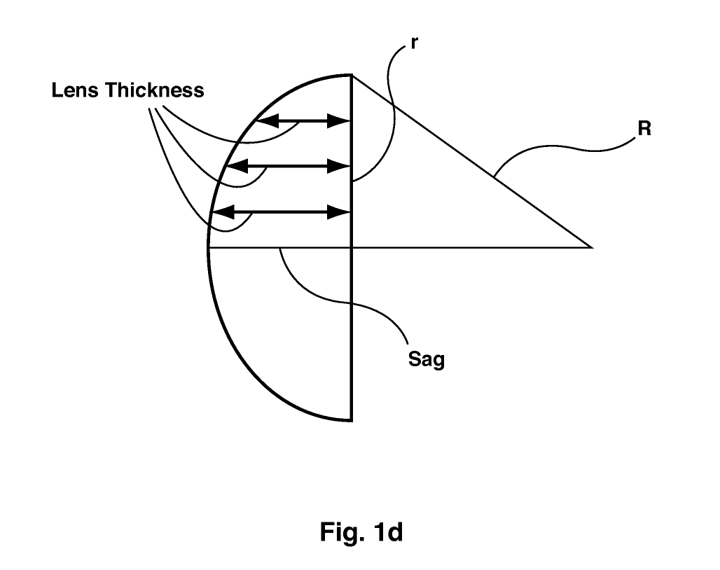

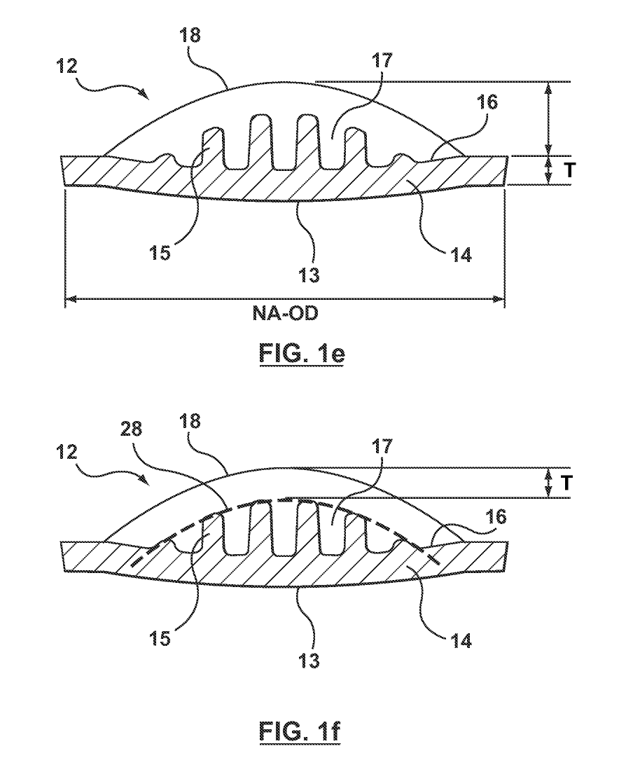

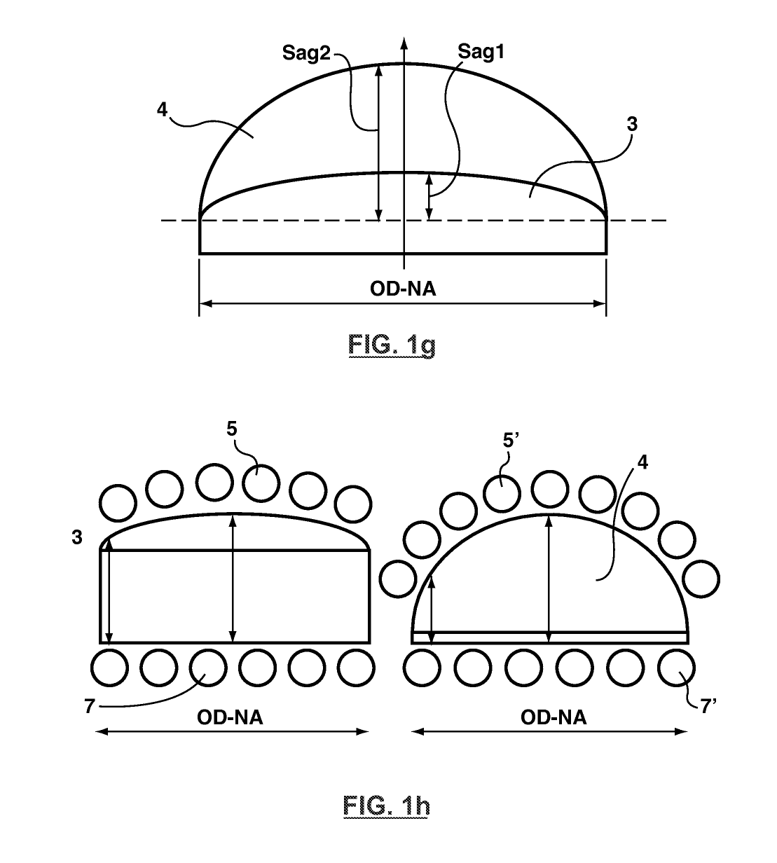

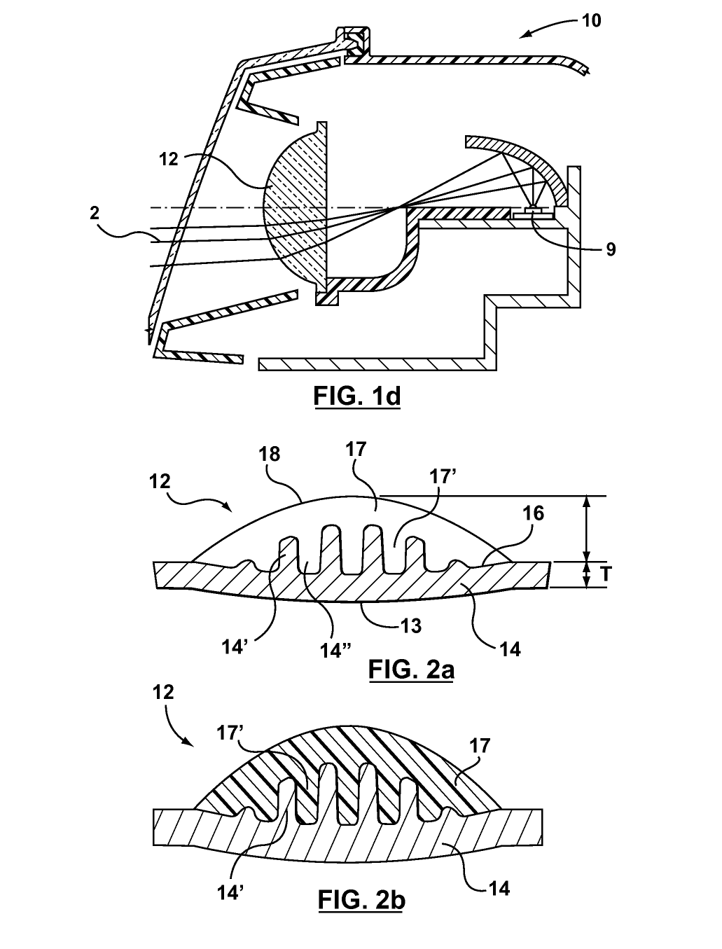

As shown in FIGS. 1 to FIGS. 5 this invention relates to an automotive illumination device such as a head lamp 10 using a solid state illumination source 9 such an LED or more specifically a white LED and a novel high sag and thick composite or integral lens 12 formed of a first lens section 14 and a second lens section 17, each section having internal elongated baffles 14′ and 17′, the first lens section 14 and the second lens section 17 being made in a multistep manufacturing process.

FIGS. 1a-b-c-e-f-g show a composite or an integral high sag thick lens 12 according to an embodiment of this invention made of two lens parts 14 and 17 each having a series of complementary or intertwined elongated baffles 14′ and 17′ whose end follow the curvature of the optically active lens surfaces such as surface 18.

FIG. 1 d shows the composite in an automotive illumination apparatus such as a head lamp 10 using a solid state illumination source 9 such as a white LED. A thick lens 12 made of two sections generates a light beam 2.

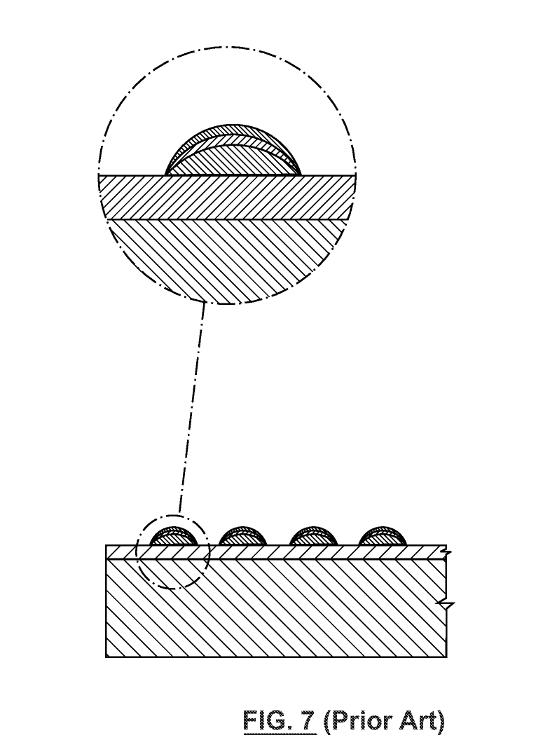

FIG. 1 h shows two lenses, lens 3 having a low sag and lens 4 having a higher sag and cooling channels in a mold. The lenses are defined by an outer diameter OD that is equivalent to the numerical aperture NA of the lenses. The distance between the upper cooling channels 5 and 7 to cool lens 3 are more evenly or equally spaced than the upper cooling channels 5′ and 7′ to cool lens 4 having a high sag. While a lens similar to lens 3 can be molded easier having a rather uniform thickness from the center to the edges, lens 4 defines a thick lens with a high sag having a steep change in thickness from the center to the edges. Because of the shape of the lenses 3 and 4 the cavity molds are different the cooling channels have to be located differently. As shown in FIG. 1h the high sag lens 4 being steep the cooling channels 5′ are also unevenly spaced apart and molding lens 4 is a single step is not recommended. The prior art method shown in FIG. 7 indicates a layering approach to make high sag lenses, where layers of materials are added on top of the active optical surface. According to the invention by designing lens 4 as a composite lens 12 made of lens section 14 and 17 eliminates the molding issues since lens sections 14 and 17 are designed as segmented lenses of a comparable thickness T as shown in FIGS. 1a-b-e-f.

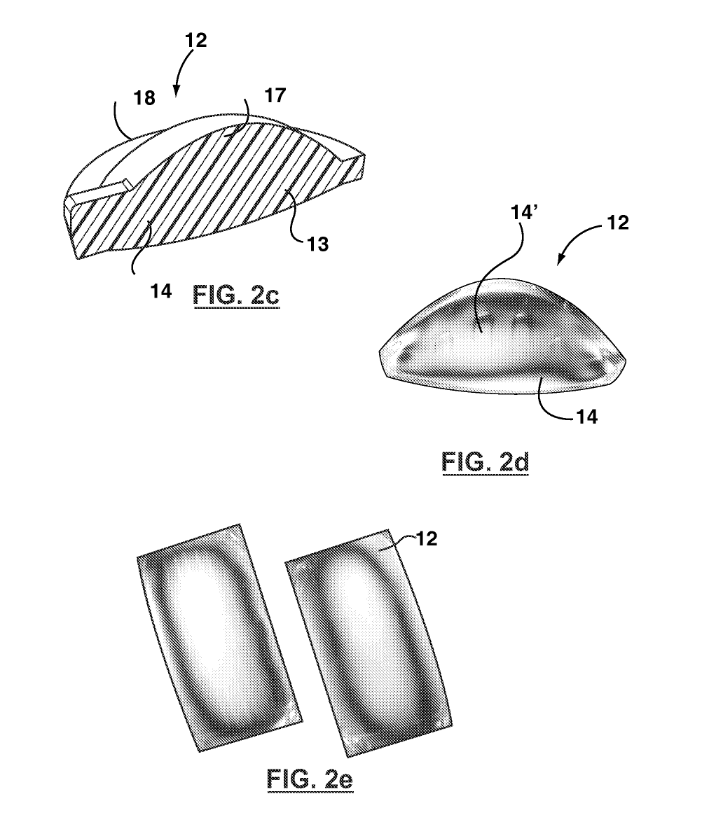

FIG. 2a-b-c show a composite or an integral high sag thick lens 12 according to an embodiment of this invention made of two lens parts 14 and 17 each having a series of complementary or intertwined elongated baffles whose end follow the curvature of the optically active lens surfaces.

FIG. 2d-e show a composite or an integral high sag thick lens 12 according to an embodiment of this invention made of two lens parts each having a series of complementary or intertwined elongated baffles 14′ and 17′ whose end follow the curvature of the optically active lens surfaces as seen under polarized light.

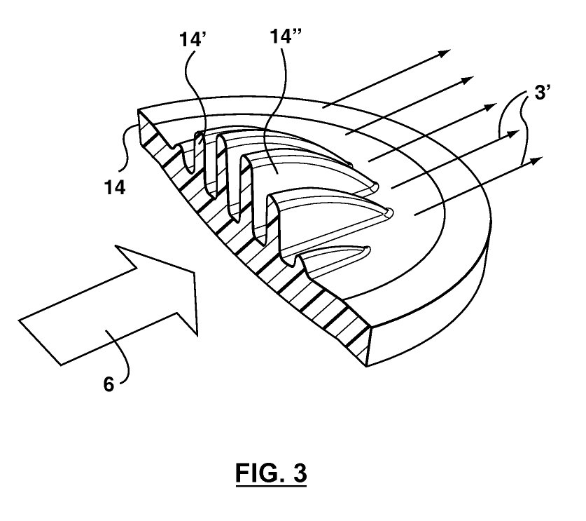

FIG. 3 shows the first molded lens section and the baffles positioned to allow the flow of the melt of the second shot without turbulence. The melt stream 6 advances between baffles 14′ in the spacing 14″ and creates a series of streams 3′.

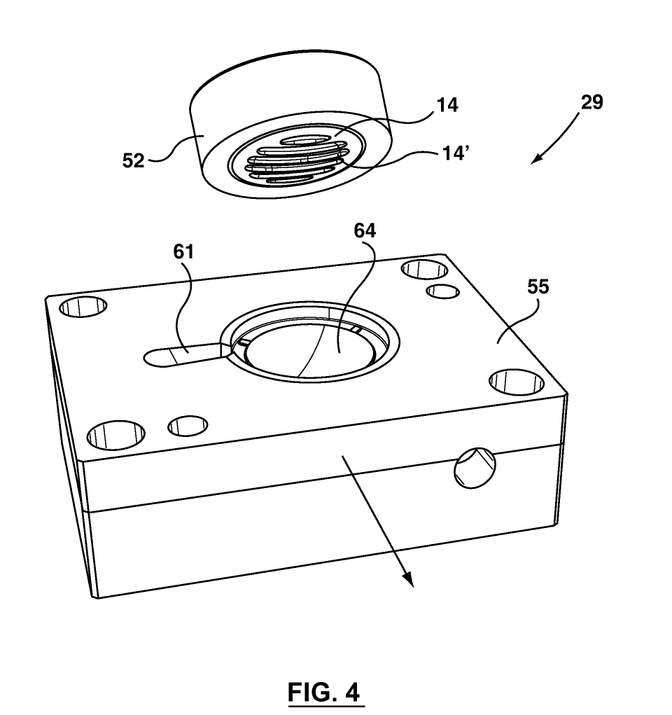

FIG. 4 shows a split/open mold assembly 29 according to an embodiment of the invention and a mold core insert 52 carrying the first molded lens part 14 having elongated baffles 14′ being positioned relative the mold gate 61 of a second mold cavity defined by upper mold insert 64 in the cavity plate 55 to inject the second shot of molten material.

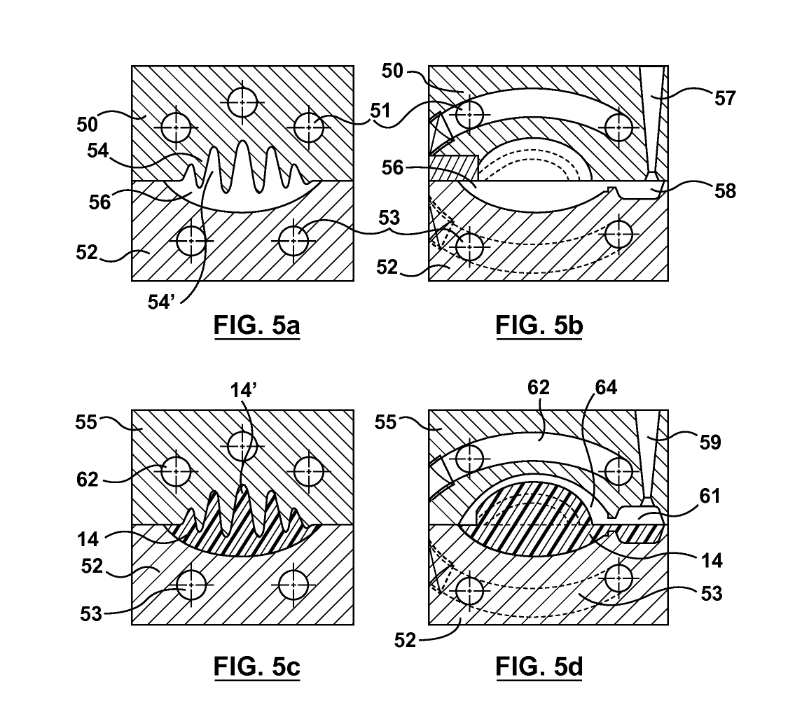

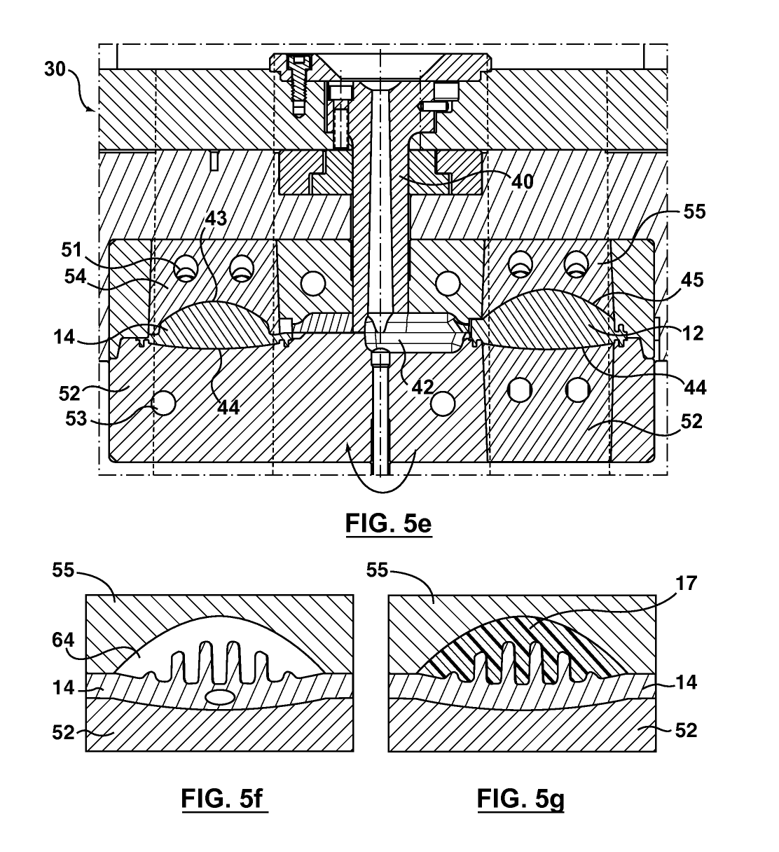

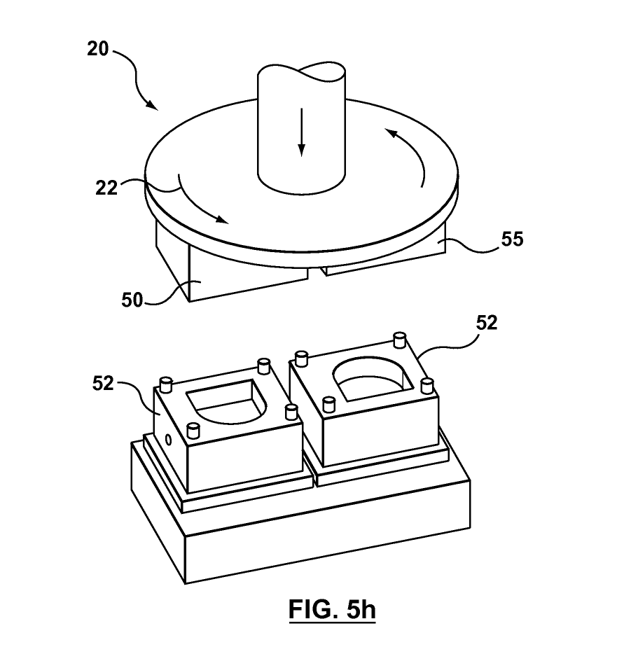

FIGS. 5a-b-c-d show a cross section through a novel injection mold used to manufacture a novel integral or composite high sag lens made of a plastic material according to an embodiment of the invention.

FIGS. 5e-f-g show a cross section through another cross section through a novel injection mold used to manufacture a novel integral or composite high sag lens made of a plastic material according to an embodiment of the invention.

FIG. 5h shows a rotary mold used to manufacture a novel integral or composite high sag lens made of a plastic material according to an embodiment of the invention.

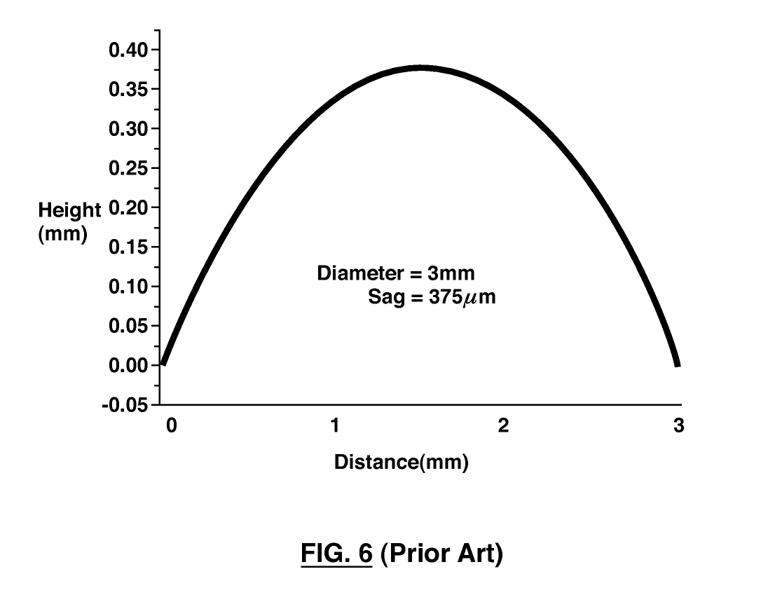

FIG. 6 shows a prior art high sag lens.

FIG. 7 shows a prior art high sag lens and the method of making a prior art high sag lens for non-automotive applications.

A prior art lens with a high sag is shown in FIG. 6 and FIG. 7 that is made using multiple layers deposited one on top of the other as shown in US 2007/0091443.

The sag of a spherical lens defines the curvature or the depth of the lens as a function of the radius of the lens and the thickness of the lens along the optical axis. This is shown in FIGS. 1d-e-f-g-h. The thickness of the lens decreases from the center towards the edge of the lens in the case of a thick lens having a high sag and such a lens is difficult to manufacture because of this characteristics.

In the case of using injection molding to make of a thick high sag thick lens as shown in FIG. 1f, the high sag and thickness rapid decrease from the center to the edges makes the cooling of the lens in the mold very unpredictable and this impacts the quality of the optical active surfaces.

The sag of the lens shown in FIG. 1d can be defined as:

Sag=R−Sqrt [R²−r²]

As mentioned in the background section, the manufacturing of a thick lens having a high sag is not easy when the lens has to be made by injection molding of a plastic resin. This is mainly caused by the cooling process in the mold. As shown in FIG. 1h a thick lens of law sag 3 is surrounded by upper cooling channels 5 and lower cooling channels 7. Because the lens has a low sag, the distance between the upper and lower cooling channels is quite constant across the lens. This make it easy to cool the lens since the thickness of the lens is quite constant/uniform and the lens is cooled uniformly. In the case of thick lens 4 shown in FIG. 1h that has a high sag, the lens 4 does not have a uniform thickness and thus the upper cooling channels 5′ and the lower cooling channels 7′ are unequally spaced and this makes the cooling step harder to control and predict. The edges of the lens cool faster than the middle of the lens and this creates non uniform or deformed top and bottom active optical surfaces. In order to make thick lenses with high sag easier to manufacture and generate active optical surfaces without any departure from the desired theoretical shape, the current invention shows a lens design where the final lens is made by fusing two or more lens sections made in previous steps. In an embodiment of the invention shown in FIG. 1b which is identical to FIG. 1a this is achieved by segmenting the final lens 12 in two lens sections 14 and 17. More than this, each lens section is further segmented into sections of equal or almost equal thickness defined as T. The thickness of the baffles 14′ and 17′ can be the same, or comparable which means different by 2%-15%. The thickness of the baffles 14′ and 17′ is also the same or comparable to the thickness of the optical active surfaces, such as 28 shown in FIG. 1f and defined between the baffles 14′ and 17′ with respective surfaces 13 and 18 shown in FIG. 1a-e-f. At least one of the first and second active optical surface 13 and 18 is curved, that is it can be spherical, cylindrical, aspheric, parabolic or free form. This lens design of the invention was chosen to facilitate the molding process so that the first lens section 14 and the second lens section 17 have thinner surfaces than the composite lens 12 and these surfaces have an equal or a comparable thickness T. In an embodiment of the invention each lens section has a series of elongated baffles 14′ and 17′ as shown in FIG. 1a that have equal or comparable thickness, the baffles having an unequal height, the top points of all the baffles generating an imaginary curve line that follows the curve of the lens surface. The position of this line created by the end portions of the first series of baffles is selected to make the upper portion of the second lens portion uniform and with a thickness comparable with the thickness of the baffles. The design of the baffles is selected in a manner that helps the manufacturing process of fusing the first lens section 14 and the second lens section 17. As shown in FIGS. 3-4-5 the baffles 14′ of the first lens section 14 are parallel or almost parallel and they have elongated lateral surfaces 140 that define spacing portions 14″ that are aligned with the gate 18′ of the second mold cavity when over-molding the second lens section 17.

According to a major objective of the invention, a thick and high sag lens 12 is designed as a fused integral or embed lens made of two sections 14 and 17. Both lens sections 14 and 17 are designed for simple and efficient manufacturing. According to an embodiment of the invention a composite high sag thick lens 12 for automotive lighting is used in conjunction with a solid state illumination source 9, such as a white LED. The composite high sag thick lens 12 is made of a first lens section 14 and a second lens section 17, the second lens section having an optical active curve surface 18. The first lens section 14 has an active optical surface 13 to receive light from the light source 9 and also series of first elongated baffles 14′ of uniform thickness and a two opposed lateral surfaces 140, the baffles 14′ having an upper surface 142 and top portion 144, the top portions 144 defining a curve line 28 shown in FIG. 1f that follows the curvature of the active surface 18 of the second lens section 17 to create an upper lens portion of uniform thickness. Also first lens section 14 includes several spacing portions 14″ between consecutive baffles 14′. Baffles 14′ have a non-equal height. In some embodiments two or three baffles 14′ need to be designed to achieve the uniform thickness of the first lens section 14. The second lens section 17 is fused to the first lens section 14 to create the composite lens 12. The second lens section 17 has an optical active surface 18 that needs to be made with high accuracy and a series of elongated baffles the baffles having a thickness comparable to the thickness of the corresponding optical active surface. The first 14′ and the second 17′ plurality of baffles are intertwined along the entire length of the lateral 140 surfaces of the first lens section 14.

According to an embodiment of the invention the composite lens 12 is designed as two separate parts 14 and 17 that have features of a uniform thickness. Each part includes an active optical surface to be exposed to light from a solid state illumination source. Each part includes several baffles 14′ and 17′ dimensioned to have a similar thickness and to have a thickness comparable to the thickness of the active optical surfaces. The baffles end portions 144 follow the curvature of the high sag lens, such as optical active surface 18. When fused together to form the composite high sag lens 12, the baffles 14′ and 17′ are intertwined or alternate in a cross section without any air gap between them and without affecting the illumination performance of the composite lens.

According to an embodiment of the invention the composite high sag lens 12 is designed so that the two lens parts 14 and 17 and the baffles of each lens part are manufactured using a two step process, or a three step process.

According to an embodiment of the invention the composite high sag lens is designed so that the baffles of each lens part is manufactured using a two step injection process of the same resin in two different injection molding cavities. This is shown in FIGS. 4-5. In the first step shown in FIGS. 5a-b-c a first lens part 14 having a first series of elongated baffles 14′ is injection molded in a first cavity 56 using molding material MA via a first mold cavity gate MG-1 58 via runner channel 57. The mold has a mold insert 50 and a series of cooling channels 51 and the mold core 52 with a series of cooling channels 53. Bothe cooling channels 51 and 53 follow the shape of the lens active surfaces 18 and 13 and they are curved in some embodiments, both of them or at least one of them, In cavity 56 baffles 54 separated by spacing portions 54′ that create molding channels in the cavity 56 to allow the melt flowing in the cavity advance along the baffles 54 with no turbulence and in a direction that allows the full venting of the cavity 56. After filling cavity 56 with molten material, the first lens part 14 is cooled in the first mold cavity 56 in close position as shown in FIG. 5c. After the cooling process that is shorter because the features of lens section 14 are almost all of an equal thickness comparable to the thickness of the baffles 14′, the mold core insert 52 retaining the first lens part 14 is transferred to form a second cavity mold 64 shown in FIG. 5d. In the second injection step, the first lens section or part 14 is retained on mold core 52 and becomes a portion of the mold core 52. In the second step, the baffles of the first lens part 14′ are aligned with respect to a second mold cavity gate MG-2 item 61 in a manner that allows a second shot of material A to flow and fill the second cavity 64 by advancing in the second cavity along the first series of elongated baffles 14′ and form the second lens 17 part with a second series of elongated baffles 17′ hat are fused with the first series of elongated baffles 14′ due to the over-molding injection process of a hot second shot of material A onto the cold and solidified material A to form the composite high sag and thick lens 12. FIG. 3 shows the flow of the molten material in the second cavity as a stream of material 6 that flows in between the baffles 14′ in the spacing 14″ to form melt stream 3′. Because the flow through baffles 14″ has no obstacles the melt flows without any turbulence and the second cavity mold 64 is filled with a proper venting facilitated by the alignment of the baffles 14′ with respect to the second mold gate 61. FIG. 5e shows another embodiment of the mold in cross section with nozzle 40 delivering the melt in two steps, first into a first cavity to form the first lens section 14 between surfaces 43 and 44, surface 44 defining the first optical active surface 13 of the lens 12 and surface 43 the top surface 146 of the first lens section 14. After the first injection step, the core insert 52 is rotated or moved into a second position carrying the solidified and cold first lens section 14 having baffles 14′. In the second position a second mold cavity is formed 64 (shown in FIG. 5f) between first lens section 14 and surface 45 of the mold insert 55 that is higher and has the spacing to inject and form the second lens section 17 over the first lens section 14. As mentioned before in the first shot a first amount of molded resin to form a first layer of the thick lens is generated. This layer includes at least two elongated baffles aligned with respect to a mold gate. In a second shot the first layer is part of the mold cavity and a second shot of the same material is injected over the first layer and in between the at least two baffles through another mold gate. This gate is aligned with the baffles so that the second shot follows a mold filling path along the baffles. In this manner the venting of the mold is done properly removing the gas and insuring that no bubbles are formed in the lens.

According to an embodiment of the invention the composite high sag lens 12 is designed so that the baffles 14′ and 17′ of each lens part is manufactured using a two step injection process of the same resin in two different injection molding cavities. According to another embodiment of the invention in the first step a first lens part 14 having elongated baffles 14′ is embossed using a first embossing or extruding device, not shown. In a second step a second lens part 17 having elongated baffles 17′is embossed or extruded using a second embossing device, not shown. In a third step, the first and the second lens parts are fused together by sliding on the second lens section 17 over or along the first lens section by aligning the baffles 17′ and 14′ and by next heating the assemble to form the composite high sag lens 12.

The composite or integral high sag lens according to this invention has been designed for automotive lighting, such as for example for automotive lighting using a solid state illumination light source such as an LED or more specifically a white LED. The embodiments of this invention are applicable to the low, high beam lenses and for the front fog lenses. The following examples illustrate some of the dimensions required for a composite or integral high sag lens according to this invention. These dimensions are informative and lenses smaller or bigger can be also designed of manufactured according to the teachings of this invention. In the following examples L is the length of the lens 12 and W is the width of the lens, since they are not circular. In other embodiments the length L can be regarded as the sole diameter of a circular lens, in other embodiments the width W can be regarded as the sole diameter of a circular lens and the values shown before are also applicable for such round or circular lenses.

### For 1: Low, High Beam Lens

Application 1.1: L100×W60×Thickness (Max 30 mm-min 4 mm)

Thickness ratio: 7.5:1 Sag: 26 mm

Application 1.2: L135×W40×Thickness (Max 18.5 mm-min 1 mm)

Thickness ratio: 18.5:1 Sag: 18 mm
For circular/round lenses the diameters are in the range of L and W shown above and the corresponding thicknesses, sag values and thickness ratios.

### For 2: Front Fog Lens

Application 2.1: L50×W30×Thickness (Max 12 mm-min 2 mm)

Thickness ratio: 6:1 Sag: 10 mm

Application 2.2: L45×W40×Thickness (Max 13 mm-min 2 mm)

Thick ratio: 6.5:1 Sag: 11 mm

What is claimed is:

1. A composite high sag thick lens for automotive lighting operable with a solid state illumination source, the lens comprising:
a first lens section having a first optical active curved surface and a first plurality of elongated baffles of unequal height, the baffles extended along the same direction and having a top portion that follows the curvature of the first active surface, the baffles having substantially parallel lateral surfaces and having a thickness comparable to the thickness of the first optical active curved surface;
a second lens section fused to the first lens section, the second lens section having a second optical active surface and a second plurality of elongated baffles, the second plurality of baffles having a thickness comparable to the thickness of the second optical active surface, where the first and the second plurality of baffles are intertwined along the entire length of the lateral surfaces of the first plurality of baffles.

2. A high sag thick lens for automotive lighting according to claim 1 where the first and the second lens sections are made of the same plastic material.

3. A high sag thick lens for automotive lighting according to claim 1 where the first and the second lens sections are made separately.

4. A high sag thick lens for automotive lighting according to claim 1 where no borders are visible with naked eyes between the baffles of the first and second lens sections.

5. A high sag thick lens for automotive lighting according to claim 1 where the baffles of the first and second lens sections are visible in polarized light.

6. A high sag thick lens for automotive lighting according to claim 1 where the baffles of the first and second lens sections have a comparable thickness.

7. A high sag thick lens for automotive lighting according to claim 1 where the baffles of the first and second lens sections have a comparable length.

8. A high sag thick lens for automotive lighting according to claim 1 where the baffles of the first and second lens sections have a comparable height.

9. A high sag thick lens for automotive lighting according to claim 1 where the baffles of the first and second lens sections have a comparable top surface curvature.

10. A high sag thick lens for automotive lighting according to claim 1 where the lens thickness ratio is between 20.0:1 and 4.00:1.

11. A high sag thick lens for automotive lighting according to claim 1 where the lens thickness ratio is between one of 7.5:1, 18.5:1, 6.5:1.

12. A high sag thick lens for automotive lighting according to claim 1 where the lens has a sag between 30.0 mm to 8.0 mm.

13. A high sag thick lens for automotive lighting according to claim 1 where the lens thickness ratio is between 20.0:1 and 4.00:1.

14. A high sag thick lens for automotive lighting according to claim 1 wherein first plurality of baffles are designed and used to direct the flow

15. A high sag thick lens for automotive lighting according to claim 1 wherein the first and the second lens sections are made in a two-step injection molding process and wherein the first and the second lens sections are fused together during a second step of an injection process wherein a molten material is molded onto the first lens section molded and cooled during first step of the injection process and wherein the molten material injected in the second step flows between a first plurality of elongated baffles formed in the first lens section to define a second plurality of elongated baffles and the second lens section.

16. A composite high sag thick lens for automotive lighting to be used in conjunction with a solid state illumination source, the lens high sag thick lens comprising:
a first lens section having an optical active curve surface and a series of elongated baffles, the baffles having a top portion and two lateral surfaces, the top portions defining a line that follows the curvature of the active surface to create an upper lens portion of uniform thickness.
a second lens section fused to the first lens section to create the composite lens, the second lens section having an optical active surface and a series of elongated baffles the baffles having a thickness comparable to the thickness of the corresponding optical active surface, wherein the first and the second plurality of baffles are intertwined along the entire length of the first baffles' lateral surfaces.
